(19) United States
(12) Patent Application Publication
(10) Pub. No.: US 2011/0117260 A1
(43) Pub. Date: May 19, 2011

(54) Method for Drying Pasta Products

(75) Inventors: Eliana Zamprogna, Winterthur (CH); Jochen Lisner, Rickenbach (CH); Christian Mühlherr, Konstanz (DE); Andreas Kratzer, Zurich (CH)

(73) Assignee: BUHLER AG, Uzwil (CH)

(21) Appl. No.: 12/996,099

(22) PCT Filed: Jun. 10, 2009
(86) PCT No.: PCT/EP2009/057218

§ 371 Date: Dec. 3, 2010

(30) Foreign Application Priority Data
Jun. 10, 2008 (DE) 10 2008 002 334.5

(51) Int. Cl. A23L 1/16; A23L 3/40; F26B 15/00

(52) U.S. Cl. 426/557; 426/451; 99/483

(57) ABSTRACT

The invention relates to a method for drying pasta products in which during the drying process the pasta products, which are present as raw pasta shapes, pass through surface states that exhibit differing value pairs of surface temperature (T) and surface moisture (U), and wherein during the drying process the surface of the raw pasta shapes remains in a viscoelastic state in which in a diagram of surface temperature (T) of the raw pasta shapes and surface moisture (U) of the raw pasta shapes (a.) the surface temperature (Tᵥ) of the raw pasta shapes is not greater than 4O° C. more than the temperature (T_{g}) on the glass transition curve of the raw pasta at the point of equal moisture of the surface, and/or (b.) the moisture (Uᵥ) of the surface of the raw pasta shapes is not more than 20% greater than the moisture on the glass transition curve of the raw pasta at the point of equal temperature of the surface. This facilitates an especially rapid drying of the pasta products without any detriment to quality.

The invention relates to a method and also a device for drying pasta products.

Pasta products can be produced, e.g., by mixing and kneading raw materials and water to form a raw pasta, transforming the raw pasta to raw pasta shapes and subsequently drying the raw pasta shapes.

During the drying of pasta products care must be particularly taken to ensure that the raw pasta shapes, during the drying process, do not undergo any adverse impairments such as fissure formation and/or excessive discoloration.

Too intense and rapid drying at high temperature, low relative atmospheric humidity and intense air circulation (high drying performance) causes shrinkage stresses which generally lead to deformations, fissures or cracks in the pasta products during or after drying thereof. Pasta products dried in this manner then readily break down into individual pieces during cooking.

In addition, such an “aggressive” drying promotes Maillard reactions in the pasta products during drying thereof, which causes the aforementioned discolorations. In addition, the drying times achieved to date in the production of pasta products are still unsatisfactorily long.

The object of the invention is to produce dried pasta products of very high quality, in particular without unwanted deformations, fissures and excessive discolorations, in a very short time, in particular having a markedly shortened drying process. This object is achieved according to the invention by means of the processes and the device according to the independent patent claims.

The process according to the invention for producing pasta products comprises a drying step for raw pasta shapes, wherein the drying conditions are selected in such a manner that at least during a subperiod of the total period of the drying process at least one subregion of the surface, preferably the entire surface, of the raw pasta shapes, remains in a viscoelastic state. Not only the extent of shrinkage stresses and of Maillard reactions during the drying process may be decreased thereby, in such a manner that the dry pasta products produced in this manner do not exhibit fissures or deformations, but also a significant shortening of the duration of the drying process is achieved.

Expediently, at least a subregion of the surface, preferably the entire surface, passes through different temperature/moisture states, in particular with an increase of the surface temperature and a decrease of the surface moisture.

Preferably in this case, the different temperature/moisture states of the surface are chosen in such a manner that they are in a viscoelastic state above the glass transition temperature. In this case, in particular, in a diagram of surface temperature and moisture a) the temperature of the surface should not be more than 40° C. above the temperature on the glass transition curve at the point of equal surface moisture and/or b) the surface moisture should be no more than 20% above the surface moisture on the glass transition curve at the point of equal temperature. The temperature/moisture states of the surface of the raw pasta shapes are accordingly always within a defined bandwidth above the glass transition curve.

The glass transition temperature is taken to mean here the temperature at which a material shows the greatest change in deformability. Below the glass temperature the material behaves in a brittle manner and above it viscoelastically. The viscoelasticity is characterized by a partially elastic, partially viscous behavior. The material only relaxes incompletely after removal of the external force, the remaining energy is removed in the form of flow processes (retardation). The expression glass transition temperature used here relates macroscopically to the raw pasta shape as a whole and not to individual microscopic components of same.

If the moisture, that is to say the water content, of a raw pasta decreases, then the glass transition temperature thereof increases. If the glass transition temperature is then measured in a raw pasta at different moistures, and these are entered into a temperature/moisture diagram, a glass transition curve is obtained for this raw pasta.

If the ambient air of a raw pasta shape has a temperature and/or moisture different from the raw pasta, an equilibrium temperature and equilibrium moisture are established on the surface of the raw pasta shape. This equilibrium surface temperature and surface moisture can be controlled in an open-loop or closed-loop manner in such a manner that the drying time is minimized. This minimization is achieved by a very low equilibrium moisture of the pasta surface being sought as rapidly as possible. This is achieved by the appropriate choice of drying air temperature and/or moisture under the precondition that the surface remains in the viscoelastic state (does not become brittle).

Preferably, for the method, a glass transition curve is prepared in the temperature/moisture diagram (T/U diagram) of the raw pasta shape. The glass transition curve is measured in this case by means of known measurement methods such as dynamic mechanical thermal analysis (DMTA); measurement by means of differential scanning calorimetry (DSC) is also possible. It is important in this case that the measurement is made on a homogeneous raw pasta in order that the transition curve reflects as far as possible the deformability of the entire raw pasta shape and not of only individual microscopic components; therefore, the measurement by means of DMTA is preferred.

Preferably, during drying the equilibrium moisture on the surface of the raw pasta shapes is monitored.

It is particularly advantageous if, during the drying, the pairs of temperature/moisture values of the surface of the raw pasta shapes are controlled in an open-loop or closed-loop manner in such a manner that they do not fall below the glass transition curve into the glassy region in a diagram of surface temperature and surface moisture.

It is particularly advantageous if, during the drying, (only) the equilibrium moisture U is monitored on the surface of the raw pasta shapes. This is the moisture on the surface of the raw pasta shapes. This surface moisture is imposed on the raw pasta shapes by the ambient drying climate and forms one of the boundary conditions (gas temperature, partial pressure of water vapor) for the moisture gradient which is established in the interior of the raw pasta shapes during drying. The moistures U are reported as (mass of water in the product)/(total mass of the water-containing product).

The drying climate is preferably an air atmosphere of defined air temperature and defined relative humidity. If required, other gases, in particular oxygen-free or low-oxygen inert gases, can also be employed as drying climate. Advantageously, the gases are nitrogen or carbon dioxide or else mixtures consisting of these having a defined partial pressure or molar fraction of water vapor present therein.

The viscoelastic state (Tᵥ; Uᵥ) occurring during drying of the raw pasta shapes at a temperature T and a moisture U should have a minimum distance ΔUₘᵢₙ=Uᵥ−U_{g} from a state at the glass transition (T_{g}; U_{g}) of the raw pasta shapes parallel to the moisture axis U (% by weight of water/total weight of the raw pasta shapes) of the temperature/moisture diagram.

During the drying, one “rides” on the glass transition curve in the T/U diagram. Surprisingly, it has been found that short drying times with a low energy input are achieved without impairment of the product properties mentioned at the outset.

Preferably, the minimum distance is in the range 0.5%<ΔUₘᵢₙ<5%, still more preferably in the range 1%<ΔUₘᵢₙ<3.5%, and most preferably in the range 1.5%<ΔUₘᵢₙ<2.5%. This ensures, in the temperature/moisture diagram (T/U), a safety margin from the glass transition curve, the crossing of which into the glass state should be prevented at least during a subperiod of the drying process. If required, and at the correct time point during drying (in particular for completion of the drying process), if appropriate a controlled crossing into the glass state which is limited in time can be made possible.

The viscoelastic state (Tᵥ; Uᵥ) occurring during drying of the raw pasta shapes at a temperature T and a moisture U should have a minimum distance ΔTₘᵢₙ=Tᵥ−T_{g} from a state at the glass transition (T_{g}; U_{g}) in parallel to the temperature axis T (in degrees Kelvin) of the temperature/moisture diagram.

Preferably, the minimum distance is in the range 1K<ΔTₘᵢₙ<10K and still more preferably in the range 1K<ΔTₘᵢₙ<5K. This also ensures in the temperature/moisture diagram (T/H) a safety margin from the glass transition curve, the crossing of which into the glass state should be prevented at least during a subperiod of the drying process, wherein, if required, and at the correct time point during drying, if appropriate a controlled crossing into the glass transition which is limited in time can be made possible.

The viscoelastic state (Tᵥ; Uᵥ) occurring during drying of the raw pasta shapes at a temperature T and a moisture U should not exceed a maximum distance ΔUₘₐₓ=Uᵥ−U_{g} from a state at the glass transition (T_{g}; U_{g}) in parallel to the moisture axis U (% by weight of water/total weight of the raw pasta shapes) of the temperature/moisture diagram.

Preferably, the maximum distance is in the range 5%<ΔUₘₐₓ<20% and still more preferably in the range 5%<ΔUₘₐₓ<10%.

The viscoelastic or rubber-like state (Tᵥ; Uᵥ) at a temperature T and a moisture U occurring during drying of the raw pasta shapes should not exceed a maximum distance ΔTₘₐₓ=Tᵥ−T_{g} from a state at the glass transition (T_{g}; U_{g}) in parallel to the temperature axis T (in degrees Kelvin) of the temperature/moisture diagram.

Preferably, the maximum distance is in the range 10K<ΔTₘₐₓ<40K, and still more preferably in the range 10K<ΔTₘₐₓ<30K.

Preferably, the glass transition curve in the temperature/moisture diagram (T/U diagram) of the present raw pasta material is provided by measurements on samples of the raw pasta before and/or during the drying. The samplings and measurements required therefor can be carried out online or offline. In this case, moistures and/or temperatures are determined on the samples which are the homogeneous moisture or homogeneous temperature in the entire volume of the sample taken after the moisture and temperature gradients within the sample have decreased at the time point of sampling.

Alternatively, or in complement thereto, the required glass transition curve in the temperature/moisture diagram (T/U diagram) of the present raw pasta material can be provided from a library in which glass transition data and raw pasta data formulae are provided.

The glass transitions in the samples can be determined by DSC measurements or DMTA measurements which are familiar to those skilled in the art.

Preferably, during at least some of the drying process, the relative humidity and/or the temperature of the drying environment of the raw pasta shapes will be controlled in an open-loop or closed-loop manner in such a manner that at least in subregions of the surface of the raw pasta shapes a glass transition from the viscoelastic state to the glassy state is prevented. In the regions in which the raw pasta shapes which are to be dried are not present in the glassy state, water molecules can diffuse more rapidly (approximately 5 to 10 times more rapidly), and so removing water and therefore the drying of the shapes proceeds more rapidly overall. Ideally, in this case, the crossing to the glass region is prevented by open-loop control of the relative humidity of the drying climate at each temperature during the drying process.

It is particularly advantageous if, in the case of the raw pasta shapes, crossing into the glass region is prevented by open-loop control of the relative humidity and/or the temperature of the drying climate during the entire drying process. Preferably, this is prevented for at least 90%, and still more preferably for at least 95%, of the total time period of the drying process. This should be the case for at least 80% of the total surface of the raw pasta shapes. It is particularly advantageous if the part of the surface which is not in the glassy state is at least 90%, and still more preferably at least 95%, of the total surface of the raw pasta shapes.

Expediently, the relative humidity of the drying climate is kept below 98%, preferably 95%, still more preferably 92%, and most preferably below 89%. This reduces the risk of condensation effects which can lead to unwanted sticking together of the raw pasta shapes during the drying process. In addition, inter alia, the drying kinetics are positively influenced thereby.

Expediently, during the drying, a majority of the volume, preferably the entire volume, or at least the entire surface of the raw pasta shapes is in a viscoelastic state above the glass transition of the raw pasta material. It is particularly preferred in this case if, during the entire time period of the drying process, the raw pasta shapes have a viscoelastic state above the glass transition. Preferably, the glass transition to the glassy state should be crossed only at the end of the drying process during the rapid cooling of the dried raw pasta shapes to ambient temperature.

Expediently, the temperature T is kept during the drying below 150° C., and preferably below 120° C. Maillard reactions in the raw pasta shapes and therefore intense discolorations during drying are thereby prevented.

Expediently, the total time tₜₒₜ of drying is kept below 280 min, preferably below 240 min, still more preferably below 200 min, and preferably below 180 min. Even with a total time tₜₒₜ below 160 min, good results are possible. This is sufficient in the method according to the invention for complete drying from an initial moisture content after extrusion to a final moisture content after the drying and makes energy-saving drying possible.

In a particularly advantageous embodiment of the method according to the invention, the time integral of the time-temperature course T(t) (in ° C.) over the total drying time tₜₒₜ is less than 20×10³ min ° C. and preferably less than 15×10³ min ° C. This also contributes to preventing drying-related discolorations and makes it possible to keep the energy expenditure of drying low and nevertheless to avoid falling below the glass transition to the glassy state during drying.

If the state of the surface of the raw pasta shapes briefly (some seconds to some minutes) falls below the glass transition into the glassy state, this is the more harmless the earlier in the drying process this takes place. In particular, falling below the glass transition for a short period during transfer of the freshly formed raw pasta shapes to the drying stage is harmless.

The raw pasta shapes during the drying process can be agitated relative to one another and/or are kept at a distance relative to one another. This prevents the raw pasta shapes from sticking together among one another.

The raw pasta shapes can be long products (e.g. spaghetti), short products (e.g. spirals) or special shapes (e.g. Nidi).

Preferably, the long products, during the drying process, are suspended on rods at a distance from one another, wherein the suspended long products, during the drying process, can readily be set into phase-offset pendulum motions with their point of suspension as point of rotation.

Preferably, the short products, during the drying process, are agitated by means of a vibrating base and/or are fluidized by means of a gas stream.

Ideally, in the invention, not only the surface but also the interior of the pasta products up to the center remain in a viscoelastic, i.e. non-glassy, state during the entire drying process, that is to say during what is termed predrying, main drying and stabilizing. This leads to the transport of moisture proceeding rapidly from the interior or the center of the pasta products to the surface thereof and also from the surface thereof into the ambient drying air. A relatively high drying rate or a relatively rapid drying saturation is achieved thereby. Since no glass transition takes place, there is no risk of fissure formation in the pasta products.

The surface and the interior or the center of the pasta products during drying reach moisture content in equilibrium with the ambient air. Therefore moistening in the stabilization step is also superfluous.

The object mentioned at the outset is additionally achieved by means of a device having the features of the independent device claim.

A device according to the invention for drying pasta products according to a method described hereinbefore comprises at least one temperature sensor and at least one moisture sensor for determining the temperature and moisture of the drying climate.

Particularly advantageously, an open-loop control unit or closed-loop control unit is assigned to the at least one temperature sensor and moisture sensor, which control unit is programmed or is programmable in such a manner that the drying of pasta products according to a method described hereinbefore is made possible. A library is connected or is connectable to the open-loop control unit or the closed-loop control unit, in which library glass transition data and raw pasta data, in particular glass transition data of raw pasta, are provided.

The invention further relates to a method of operating a device as described hereinbefore, wherein the device is controlled in an open-loop or closed-loop manner in such a manner that during correct use of the device for drying raw pasta shapes having a maximum thickness of <2 mm and/or a maximum wall thickness of <1.75 mm a total time tₜₒₜ of the drying process of less than 280 min, preferably less than 200 min, particularly preferably less than 160 min, results.

Table 1 shows drying conditions which can be applied in a drying system according to the invention.

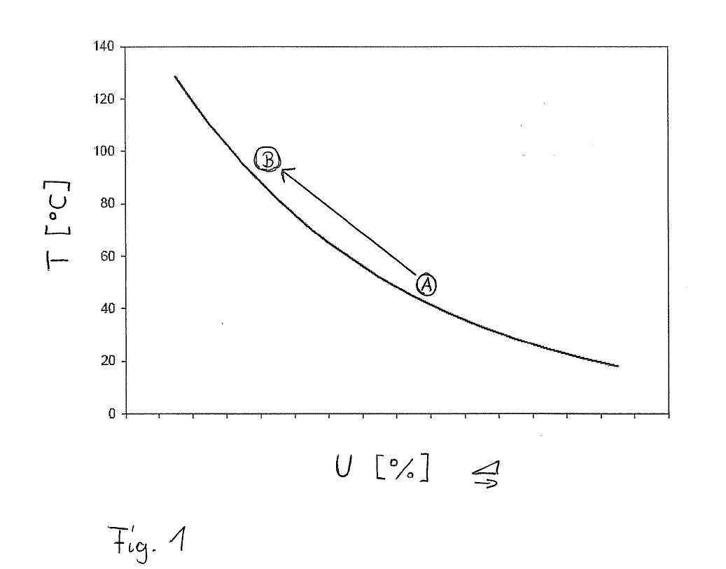

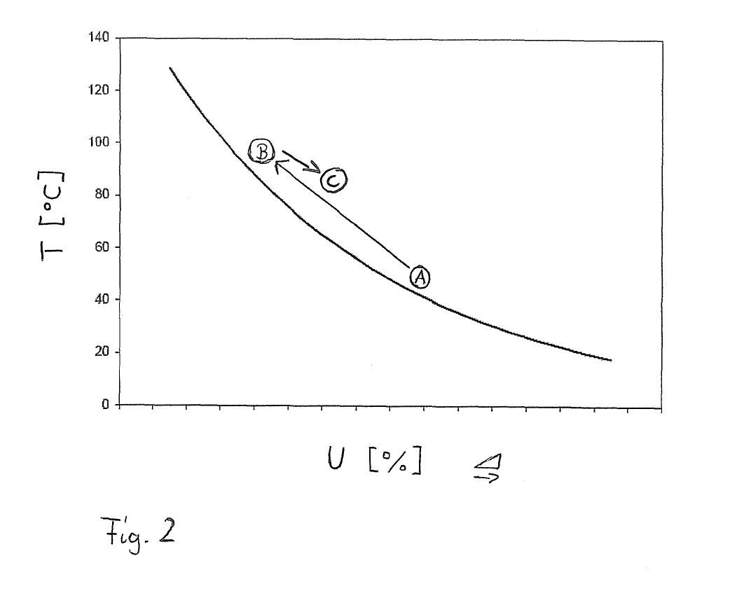

TABLE 1

| | | | | State in |
|---|---|---|---|---|
| | | | | T/U diagram |
| State of the surface of | | | | according to |
| the raw pasta shapes | T [° C.]¹ | RF [%]¹ | t [min] | FIGS. 1 and 2 |
| viscoelastic | 50 | 88 | 8 | A |
| viscoelastic | 55 | 86 | 8 | Transition A->B |
| viscoelastic | 60 | 84.5 | 8 | Transition A->B |
| viscoelastic | 65 | 83 | 8 | Transition A->B |
| viscoelastic | 70 | 82 | 8 | Transition A->B |
| viscoelastic | 75 | 80 | 8 | Transition A->B |
| viscoelastic | 80 | 77 | 8 | Transition A->B |
| viscoelastic | 90 | 71 | 8 | Transition A->B |
| viscoelastic | 95 | 66 | 8 | Transition A->B |
| viscoelastic | 97 | 63 | 35 | B |
| viscoelastic | 90 | 80 | 45 | C |

¹based on the conditioned air before flowing through the product chamber

The pasta products listed in this example were produced from commercially available hard wheat semolina at a water content of 31 g/100 g of total weight in a pasta product extrusion system suitable therefor to give the format of spaghetti using a pasta product die (hole diameter 1.75 mm). The pasta products that are extruded and suspended on rods were transferred to the drying system in which drying was performed by means of convective drying using conditioned air. The conditions of this drying air (temperature T and relative humidity RH) were applied over the total trying time of 152 min in accordance with the preset values given in the table. The total drying time is the sum of the residence times t (see 3rd column of the table) for a respective climate (T/RH combination, see column 1 and column 2 of the table).

FIG. 1 shows a glass transition curve in a temperature/moisture diagram by way of example. The surface temperature T of the raw pasta shape is plotted against the equilibrium surface moisture U of the raw pasta shape, reported in % by weight, based on the total weight of the raw pasta shape. With increasing moisture, the glass transition temperature decreases. In the method according to the invention, raw pasta shapes are brought to the first treatment zone with a surface in the temperature/moisture state A. In this zone the raw pasta shapes are brought stepwise to the temperature/moisture state B. In this process, by adapting the temperature and moisture of the drying climate, the equilibrium moisture of the surface of the raw pasta shapes is kept above the glass transition curve. In the second treatment zone, the surface of the raw pasta shapes is kept for a relatively long time in the temperature/moisture state B. Because the surface remains in the viscoelastic state, the moisture contained in the raw pasta shapes can diffuse particularly well to the surface and pass through it.

In FIG. 2, compared with FIG. 1, in addition a final step of stabilization of the raw pasta shapes is shown in which the surface of the raw pasta shapes is kept for a relatively long time in the temperature/moisture state C. This serves for standardizing the moisture over the entire thickness of the raw pasta shape.

1-25. (canceled)

26. A method for drying pasta products, in which the pasta products which are present as raw pasta shapes pass during the drying process through surface states that have different pairs of values of surface temperature and surface moisture, and wherein at least a subregion of the raw pasta shapes for at least some of the drying operation remains in a viscoelastic state in which in a diagram of surface temperature of the raw pasta shape and surface moisture of the raw pasta shape
a) the surface temperature of the raw pasta shape is no more than 40° C. above the temperature on the glass transition curve of the raw pasta at the point of equal surface moisture;
and/or
b) the surface moisture of the raw pasta shape is no more than 20% above the moisture on the glass transition curve of the raw pasta at the point of equal surface temperature.

27. The method as claimed in claim 26, wherein the subregion of the raw pasta shapes remains in a viscoelastic state for the entire drying operation.

28. The method as claimed in claim 26, wherein the surface temperature of the raw pasta shape is no more than 30° C. above the temperature on the glass transition curve of the raw pasta at the point of equal surface moisture.

29. The method as claimed in claim 28, wherein the surface temperature of the raw pasta shape is no more than 20° C. above the temperature on the glass transition curve of the raw pasta at the point of equal surface moisture.

30. The method as claimed in claim 26, wherein the surface moisture of the raw pasta shape is no more than 15% above the moisture on the glass transition curve of the raw pasta at the point of equal surface temperature.

31. The method as claimed in claim 30, wherein the surface moisture of the raw pasta shape is no more than 10% above the moisture on the glass transition curve of the raw pasta at the point of equal surface temperature.

32. The method as claimed in claim 26, wherein the surface of the raw pasta shapes during the drying process runs through states that have different pairs of temperature/moisture values.

33. The method as claimed in claim 32, wherein passing through the states having different pairs of temperature/moisture values takes place with an increase of the surface temperature and a decrease of the surface moisture.

34. The method as claimed in claim 26, wherein the surface temperature and moisture of the raw pasta shapes are controlled in an open-loop or closed-loop manner during the drying process in such a manner that the time required for the total drying operation is minimized.

35. The method as claimed in claim 34, wherein, for the open-loop or closed-loop control of the method, a glass transition curve in a diagram of surface temperature and surface moisture of the raw pasta shape is used.

36. The method as claimed in claim 26, wherein the raw pasta shapes during the drying process are agitated relative to one another and/or are kept at a distance relative to one another.

37. The method as claimed in claim 26, wherein the glass transition curve was/is determined by measurements on samples of the raw pasta before and/or during the drying.

38. The method as claimed in claim 26, wherein the glass transition curve is taken from or derived from a library of glass transition data and/or raw pasta data.

39. The method as claimed in claim 26, wherein during at least a part, preferably during the entire drying process, the relative humidity of the drying environment and/or the temperature of the drying environment of the raw pasta shapes is/are controlled in an open-loop or closed-loop manner in such a manner that at least a subregion of the surface, preferably the entire surface, of the raw pasta shapes does not become brittle, but remains in a viscoelastic state.

40. A device for drying pasta products according to a method as claimed in claim 26, comprising at least one temperature sensor and at least one moisture sensor for determining the temperature and moisture of the drying climate.

41. The device as claimed in claim 40, wherein an open-loop control unit or closed-loop control unit is assigned to the at least one temperature sensor and moisture sensor, which control unit is programmed or is programmable in such a manner that the drying of pasta products according to a method as claimed in claim 26 is made possible.

42. The device as claimed in claim 41, wherein a library is connected or is connectable to the open-loop control unit or the closed-loop control unit, in which library glass transition data and raw pasta data are provided.

43. A method for operating a device as claimed in claim 40, wherein the device is controlled in an open-loop or closed-loop manner in such a manner that during correct use of the device for drying raw pasta shapes having a maximum thickness of <2 mm and/or a maximum wall thickness of <1.75 mm a total time tₜₒₜ of the drying process of less than 280 min.

44. A pasta product produced by a method as claimed in claim 26.

45. A pasta product produced by using a device as claimed in claim 40.

46. A pasta product as claimed in claim 45, wherein the device is controlled in an open-loop or closed-loop manner in such a manner that during correct use of the device for drying raw pasta shapes having a maximum thickness of <2 mm and/or a maximum wall thickness of <1.75 mm a total time tₜₒₜ of the drying process of less than 280 min.
